(19) United States
(12) Patent Application Publication
(10) Pub. No.: US 2025/0192608 A1
(43) Pub. Date: Jun. 12, 2025

(54) Power Grid Transmission and Distribution Cooperative Dispatching Method in Power Market Environment

(71) Applicant: Guizhou Power Grid Co., Ltd., Guiyang (CN)

(72) Inventors: Julong CHEN, Guiyang (CN); Yu ZHANG, Guiyang (CN); Yang LI, Guiyang (CN); Xueyong TANG, Guiyang (CN); Qingsheng LI, Guiyang (CN); Rong WANG, Guiyang (CN); Zhen LI, Guiyang (CN); Jierui YANG, Guiyang (CN); Zhaofeng ZHANG, Guiyang (CN); Jiang DAI, Guiyang (CN); Yan ZHANG, Guiyang (CN); Lijin HUANG, Guiyang (CN); Zhongjing ZHANG, Guiyang (CN); Wen YAN, Guiyang (CN); Dameng LIU, Guiyang (CN); Ludong CHEN, Guiyang (CN); Qinfeng MA, Guiyang (CN); Linbo WANG, Guiyang (CN); Ning LUO, Guiyang (CN); Chaohong BIE, Guiyang (CN); Yuerong ZHU, Guiyang (CN)

(21) Appl. No.: 19/010,903

(22) Filed: Jan. 6, 2025

Related U.S. Application Data
(63) Continuation of application No. PCT/CN2024/135886, filed on Nov. 29, 2024.

(30) Foreign Application Priority Data
Dec. 11, 2023 (CN) 2023116938073

(51) Int. Cl. H02J 13/00; G06Q 10/0631; G06Q 50/06

(52) U.S. Cl. CPC H02J 13/00002; G06Q 10/06313; G06Q 50/06

(57) ABSTRACT

Disclosed is a power grid transmission and distribution cooperative dispatching method and system in a power market environment, relating to the technical filed of power market. The method includes: power grid transmission and distribution data are collected, and economic dispatching modeling is carried out on a hybrid system containing hydro-thermal power; linearization processing is carried out on nonlinear terms in the model; and accelerated solving is carried out on the model by adopting Benders decomposition, so that power gird transmission and distribution cooperative dispatching is optimized. The integration capacity of the power system containing hydro-thermal power to the renewable energy is enhanced, and the utilization efficiency of resources is improved, and the solving process is simplified in the present invention.

### CROSS-REFERENCE TO RELATED APPLICATIONS

The present application claims priority to Chinese Patent Application No. 2023116938073, filed on Dec. 11, 2023, the entire disclosure of which is incorporated herein by reference.

### TECHNICAL FIELD

The present invention relates to the technical filed of power market, in particular to a power grid transmission and distribution cooperative dispatching method and system in a power market environment.

### BACKGROUND

With the continuous deepening of reform of the power market, the consumption and accommodation mode of a power system to renewable energy needs to be reformed, the traditional non-marketized consumption and accommodation mode can no longer meet the development requirement of the current green power system, and the development of a marketized consumption and accommodation mode is a necessary choice for further promoting the vigorous development of the renewable energy. In large-scale power generation and grid connection of the renewable energy, the output of a traditional thermal power generating unit is constrained, standby resources of the system are obviously reduced, and then self adjustment capacity of power balance of the system is reduced, so the dispatching risk caused by the renewable energy with an uncertain power output value is difficult to deal with. Meanwhile, as distributed resources are connected into a power distribution network, the operation mode of a power distribution system is more flexible and diversified, the distribution network is increasingly active and marketized, so that the interaction relationship between power transmission and distribution networks is tighter, and the flexible controllability of the power distribution network is greatly increased, while the organization mode of mutual split of traditional power transmission and distribution networks cannot fully play the decisive role of market in resource allocation. In order to better realize economic dispatching of the power system in the market environment, power grid transmission and distribution cooperative dispatching in the power market needs to be established, and a power distribution system provides a series of auxiliary services for a power transmission system through cooperative operation of the power transmission and distribution systems, so that the power transmission system safely operates more efficiently and more flexibly.

Aiming at the defects, first, by collecting power grid transmission and distribution data, economic dispatching modeling is carried out on a hybrid system containing hydro-thermal power, and the advantages of the renewable energy and traditional energy are effectively combined. Compared with the relevant art, the method provides a more reasonable dispatching strategy for effective connection and utilization of the renewable energy. In model processing, nonlinear terms in the model are subjected to linearization processing, so that the computation complexity is effectively reduced, and the solving efficiency is improved. In addition, accelerated solution is carried out on the model by adopting Benders decomposition, so that the efficiency of the power gird transmission and distribution cooperative dispatching is further optimized. These innovations not only promote economy and safety of the power system, but also enhance the adaptability of the system to the uncertainty of the renewable energy. Through the innovative method of the power grid transmission and distribution cooperative dispatching, the defects of the relevant art in the aspects of large-scale grid connection of the renewable energy, power grid resource dispatching and marketization consumption and accommodation are effectively overcome, and a novel solution is provided for the sustainable development of the power system.

### SUMMARY

In view of the existing problems mentioned above, the present invention is provided.

Therefore, the technical problem solved by the present invention is: an existing transmission and distribution power grid dispatching method has the problems of low efficiency, low flexibility, high complexity and difficulty in enabling a power transmission system to safely operate more efficiently and more flexibly.

In order to solve the above technical problem, the present invention provides the following technical solution: a power grid transmission and distribution cooperative dispatching method in a power market environment includes: collecting power grid transmission and distribution data, and carrying out economic dispatching modeling on a hybrid system containing hydro-thermal power; carrying out linearization processing on nonlinear terms in the model; and carrying out accelerated solving on the model by adopting Benders decomposition, so that power gird transmission and distribution cooperative dispatching is optimized.

As a preferred solution of the power grid transmission and distribution cooperative dispatching method in a power market environment of the present invention, the power grid transmission and distribution data includes power generation data, power grid data, market data and environment data; the power generation data includes reservoir level, fuel consumption rate, generator set efficiency and emission efficiency; the power grid data includes real-time load data, line loss and line impedance; the market data includes real-time electricity price; and the environment data includes temperature, humidity and precipitation.

As a preferred solution of the power grid transmission and distribution cooperative dispatching method in a power market environment of the present invention, the economic dispatching modeling includes: an optimization objective is that the total operation cost of the system is the minimum, and the total operation cost of the system includes coal consumption cost of operation cost of a thermal power station, startup and shutdown cost of operation cost of the thermal power station and spilled water cost of a hydropower station, expressed as:

$$min F = {{\sum }_{i = 1}}^{N} {\sum }_{t = 1}^{T} \{ {u}_{i , t} , {f}_{i} ( {P}_{i , t} ) + {u}_{i , t} ( 1 - {u}_{i , t - 1} ) {C}_{i , t} \} + {{\sum }_{j = 1}}^{M} {\sum }_{t = 1}^{T} {λ}_{j} {S}_{j , t}$$

where F is a target function when the total operation cost of the system is the minimum, i and N are respectively the serial number and total number of thermal power generating units, j and M are respectively the serial number and total number of cascade hydropower stations, t and T are respectively time-period serial number and total number, P_{i,t} is output of the ith thermal power generating unit in time period t, u_{i,t} are state variables of the unit, 0 indicates shutdown state of the unit, 1 indicates startup state, C_{i,t} represents startup cost of the unit i in time period t, S_{j,t} represents spilled water volume of the hydropower station j in time period t, λⱼ is a penalty factor of spilled water of the hydropower station, converting the spilled water volume to spilled water cost, and computing operation time of the unit i in time period t, expressed as:

$${f}_{i} ( {P}_{i , t} ) = {aP}_{i , t}^{2} + {bP}_{i , t} + c$$

where a,b,c is consumption characteristic parameter of operation of the unit.

As a preferred solution of the power grid transmission and distribution cooperative dispatching method in a power market environment of the present invention, the economic dispatching modeling further includes: aiming at a hybrid system containing hydro-thermal power, carrying out constraining on the system, including computing power constraint and rotating reserve constraint of the system, power balance of a power system is balance of power supply and demand, the total power generation of the power system is balanced with total load of a power distribution network connected to an active network, and carrying out modeling on power balance constraint, expressed as:

$${{\sum }_{t = 1}}^{N} {P}_{i , t} + {\sum }_{{j = 1}^{}}^{M} {P}_{j , t} = {D}_{t}$$

P_{i,t} [symbol] P_{j,t} respectively represent output of a thermal power generating unit i and a hydropower station j in time period t, Dₜ represents algebraic sum of equivalent load of different power distribution networks in time period t, distributed power resources are connected to the power distribution network, the power distribution network changes from passive to active network, and during calculation and analysis of the active network, if there are excessive distributed power resources in the power distribution network, the equivalent load is negative; and calculating rotating reserve constraint, expressed as:

$${\sum }_{i = 1}^{N} {u}_{i , t} ( {P}_{i , m ax} - {P}_{i , t} ) + {\sum }_{j = 1}^{M} {u}_{j , t} ( {P}_{j , m ax} - {P}_{j , t} ) = {η}_{t} {D}_{t}$$

P_{i,max} [symbol] P_{j,max} respectively represent upper limits of output of the thermal power generating unit i and the hydropower station j, and ηₜ represents a coefficient of reserve capacity of the system in time period t; establishing operation constraint of the unit, including output constraint, climbing constraint and minimum startup-shutdown time constraint of the unit; and calculating output constraint of the unit, expressed as:

$$\{ \begin{matrix}{P}_{i , m i n} \leq {P}_{i , t} \leq {P}_{i , m ax} \\ {P}_{j , m i n} \leq {P}_{j , t} \leq {P}_{i , m ax}\end{matrix}$$

P_{i,min} [symbol] P_{j,min} respectively represent lower limits of output of the thermal power generating unit i and the hydropower station j; and calculating climbing constraint, expressed as:

$$\{ \begin{matrix}\vert {P}_{i , t} - {P}_{i , t - 1} \vert \leq {R}_{i , m ax} \\ \vert {P}_{j , t} - {P}_{j , t - 1} \vert \leq {R}_{j , m ax}\end{matrix}$$

R_{i,max} is upper limit of climbing constraint of the thermal power generating uniti, and R_{j,max} represents upper limit of climbing constraint of the hydropower station j; and calculating the minimum startup-shutdown time constraint, expressed as:

$$\{ \begin{matrix}( {u}_{i , t - 1} - {u}_{i , t} ) ( {T}_{i , t - 1} - {\underline{T}}_{j , on} ) \geq 0 \\ ( {u}_{i , t} - {u}_{i , t - 1} ) ( - {T}_{i , t - 1} - {\underline{T}}_{j , off} ) \geq 0\end{matrix}$$

Tₒₙ [symbol] T_{off} are respectively minimum operation time and minimum startup-shutdown of the unit, and T_{i,t} represents continuous operation time or continuous shutdown time of the unit i in time period t; establishing hydropower station constraint, including water volume balance constraint, water head constraint, power generation flow constraint, reservoir outflow constraint, water level constraint, and water level-reservoir capacity and unit output relationship constraint; and calculating the water volume balance constraint, expressed as:

$$\{ \begin{matrix}{V}_{j , t + 1} = {V}_{j , t} + 3600 \times ( {I}_{j , t} - {Q}_{j , t} + {\sum }_{k ∈ {K}_{j}} {Q}_{j , t - {τ}_{j , k}}^{k} ) Δt \\ {Q}_{j , t} = {q}_{j , t} + {s}_{j , t}\end{matrix}$$

V_{j,t} is reservoir capacity of the station j in time period t, I_{j,t} is reservoir inflow of the station j in time period t, Q_{j,t} is reservoir outflow of the station j in time period t, Q_{j,t-τ}_{_{j,k}}^{k} is reservoir outflow of the station j in the kth direct upstream station in time period t-τ_{j,k}, Kⱼ is a set of direct upstream stations of the station j, τ_{j,k} is flow time-lag of the station j to the upstream station k, q_{j,t} is power generation flow of the station j in time period t, and s_{j,t} is spilled water flow of the station j in time period t; and calculating the water head constraint, expressed as:

$$\{ \begin{matrix}{h}_{j , t} = \frac{{Z}_{j , t} + {Z}_{j , t - 1}}{2} - {h}_{t}^{loss} \\ {h}_{t}^{loss} = {f}_{loss} ( {q}_{j , t} )\end{matrix}$$

h_{j,t} [symbol] Z_{j,t} [symbol] hₜ^{loss} are respectively power generation water head, water level and water head loss of the station j in time period t, and the water head loss and the power generation flow are in a nonlinear relationship; and calculating the power generation flow constraint, the reservoir outflow constraint and the water level constraint, expressed as:

$$\{ \begin{matrix}{\underline{q}}_{j , t} \leq {q}_{j , t} \leq {\overline{q}}_{j , t} \\ {\underline{Q}}_{j , t} \leq {Q}_{j , t} \leq {\overline{Q}}_{j , t} \\ {\underline{Z}}_{j , t} \leq {Z}_{j , t} \leq {\overline{Z}}_{j , t}\end{matrix}$$

q_{j,t} is lower limit of power generation flow of the station j in time period t, q̅_{j,t} is upper limit of power generation flow of the j in time period t, Q_{j,t} is lower limit of reservoir outflow of the station j in time period t, Q̅_{j,t} is upper limit of reservoir outflow of the station j in time period t, Z_{j,t} is lower limit of water level of the station j in time period t, and Z̅_{j,t} is upper limit of water level of the station j in time period t; and calculating the water level-reservoir capacity and unit output relationship constraint, expressed as:

$$\{ \begin{matrix}{Z}_{j , t} = {f}_{j , v} ( {V}_{j , t} ) \\ {P}_{j , t} = {f}_{j , q , h} ( {q}_{j , t} , {h}_{j , t} )\end{matrix}$$

where f_{j,v}(V_{j,t}) represents nonlinear relationship of the water level and reservoir capacity of each hydropower station, and f_{j,q,h}(q_{j,t}, h_{j,t}) represents a two-dimensional relation of output, power generation flow and water head of the station j.

As a preferred solution of the power grid transmission and distribution cooperative dispatching method in a power market environment of the present invention, the linearization processing includes carrying out target function linearization on the model, a target function includes operation cost of thermal power and spilled water penalty cost of hydropower, coal consumption cost in the operation cost of thermal power is a quadratic function of unit output, the coal consumption cost is a nonlinear function of unit output, and carrying out linearization output, expressed as:

$$\{ \begin{matrix}{f}_{i} ( {P}_{i , t} ) = {\sum }_{m = 1}^{{M}_{m ax}} {k}_{i , m} {P}_{i , t , m} + {u}_{i , t} ( {aP}_{i , m i n}^{2} + {bP}_{i , m i n} + c ) \\ {P}_{i , t} = {\sum }_{m = 1}^{{M}_{m ax}} {P}_{i , t , m} + {u}_{i , t} {P}_{i , m i n} \\ 0 \leq {P}_{i , t , m} \leq Δ {P}_{i , m}\end{matrix}$$

where m [symbol] Mₘₐₓ are serial number and total segment number of linearization segments, k_{i,m} is the slope of the mth segment after an operation cost curve of the thermal power generating unit is linearized, P_{i,t,m} is output of the uniti in the mth segment in time period t, and ΔP_{i,t} is a power difference of the average segment.

As a preferred solution of the power grid transmission and distribution cooperative dispatching method in a power market environment of the present invention, the linearization processing further includes carrying out linearization on a nonlinear relationship constraint existing.

the water level-reservoir capacity and the water head loss-power generation flow are respectively in one-dimensional nonlinear relationship, carrying out linear interpolation on the nonlinear function by introducing 0-1 variables in the water level-reservoir capacity function, and the linearized model is expressed as:

$$\{ \begin{matrix}{\underline{V}}_{j} = {V}_{j}^{0} < {V}_{j}^{1} < … < {V}_{j}^{k} < … {V}_{j}^{K} = {\overline{V}}_{j} \\ {r}_{j , t}^{k} {V}_{j}^{k - 1} \leq {V}_{j , t}^{k} \leq {r}_{j , t}^{k} {V}_{j}^{k} \\ {Z}_{j , t} = {\sum }_{k = 1}^{K} \{ {r}_{j , t}^{k} {Z}_{j}^{k - 1} + \frac{{Z}_{j}^{k} - {Z}_{j}^{k - 1}}{{V}_{j}^{k} - {V}_{j}^{k - 1}} \times ( {V}_{j , t}^{k} - {r}_{j , t}^{k} {V}_{j}^{k - 1} ) \}\end{matrix}$$

where Zⱼ^{k} [symbol] Vⱼ^{k} respectively represent water level and reservoir capacity segmentation points of a water level-reservoir capacity curve of the station j, the numerical correspondence of the segmentation points is based on historical data, Vⱼ represents lower limit of reservoir capacity of the station j, V̅ᵢ represents upper limit of the reservoir capacity of the station j, V_{j,t}^{k} represents the value of reservoir capacity of the station j in the kth interval during time period t, r_{j,t}^{k} are indicator variables 0-1, which represent whether the reservoir capacity of the station j is in the kth discrete interval or not during time period t, where 1 indicates that it is in the interval, and 0 indicates that it is not in the interval;

output constraint of the hydropower unit is two-dimensional nonlinear constraint, by discretizing the reservoir capacity and power generation flow into n and m segments respectively, the average value of the upper and lower limits of each segment of the reservoir capacity is taken as the interval reservoir capacity of the segment, for a specific reservoir capacity interval, the output of the unit is simplified into a unary function of power generation flow, and the linearization relationship is calculated by piecewise interpolation.

As a preferred solution of the power grid transmission and distribution cooperative dispatching method in a power market environment of the present invention, carrying out accelerated solving on the model by adopting Benders decomposition includes: decomposing an original problem into main and sub problems based on model linearization by adopting the Benders decomposition method, alternately solving main and sub problems, calculating the optimal solution, the main problem is a unit combination problem without safety constraint, and the sub problem is power flow verification of the system.

When the value of a target function of the sub problem in the time period is smaller than a threshold, the solution of the main problem meets a power flow equation and operation constraint in the time period t, and the sub problem is a feasible sub problem.

when the value of the target function of the sub problem in time period is greater than or equal to a threshold, the solution of the main problem cannot meet a power flow equation and operation constraint in the time period t, the sub problem is an infeasible sub problem, for the infeasible sub problem, feeding out-of-limit information back to the main problem, correcting the solution of the main problem in the corresponding time period, and performing Benders decomposition in the correction process, expressed as:

$${\sum }_{l ∈ L} ( {ε}_{l}^{+} + {ε}_{l}^{-} ) + {\sum }_{i ∈ N} {λ}_{p , i} ( {P}_{i} - {P}_{i}^{0} ) + {\sum }_{i ∈ N} {λ}_{u , i} ( {U}_{i} - {U}_{i}^{0} ) \leq 0$$

where εₗ⁺ [symbol] εₗ⁻ are forward power flow slack and reverse power flow slack of a line l respectively, λ_{p,i} [symbol] λ_{u,i} are Lagrangian multipliers of unit output constraint and startup-shutdown state constraint respectively, Pᵢ⁰ [symbol] Uᵢ⁰ are respectively values of upper iteration, and carrying out power grid transmission and distribution cooperative dispatching optimization based on a decomposed model.

Another objective of the present invention is to provide a power grid transmission and distribution cooperative dispatching system in a power market environment, which may carry out linearization on a target function of a model and the nonlinear relationship constraint by carrying out linearization processing on nonlinear terms in the model, so that the problem of low accuracy of existing transmission and distribution power grid dispatching is solved.

As a preferred solution of the power grid transmission and distribution cooperative dispatching system in a power market environment of the present invention, an economic dispatching module, a linearization processing module and a decomposition optimization module are included; the economic dispatching module is configured to collect power grid transmission and distribution data, and carry out economic dispatching modeling on a hybrid system containing hydro-thermal power; the linearization processing module is configured to carry out linearization processing on nonlinear terms in the model and carry out linearization on the target function of the model and the nonlinear relationship constraint; and the decomposition optimization module is configured to carry out accelerated solving on the model by adopting Benders decomposition, so that power gird transmission and distribution cooperative dispatching is optimized.

A computer device includes a memory and a processor, a computer program is stored on the memory, and when the computer program is executed by the processor, the steps of the power grid transmission and distribution cooperative dispatching method in a power market environment are implemented.

A computer-readable storage medium in which a computer program is stored, and when the computer program is executed by a processor, the steps of the power grid transmission and distribution cooperative dispatching method in a power market environment are implemented.

The present invention has the beneficial effects that: for the power grid transmission and distribution cooperative dispatching method in a power market environment provided by the present invention, economic dispatching modeling is carried out on a hybrid system containing hydro-thermal power, the integration capacity of the power system to the renewable energy is enhanced by integrating characteristics of different energy types and respective operation cost, and the utilization efficiency of resources is improved; the complex nonlinear terms in the original model are converted to linear representations, so that the model is easier to solve, meanwhile, core characteristics of the original model are reserved, and capacity of rapid response is provided for power grid dispatching; and by carrying out accelerated solving by adopting the Benders decomposition method, a problem is decomposed into a main problem and a sub problem, which may be independently solved, so that the overall solving efficiency, as well as scalability and flexibility are improved, and the present invention obtains better effects in the aspects of accuracy, efficiency and flexibility.

### BRIEF DESCRIPTION OF DRAWINGS

In order to describe the technical solutions in the embodiments of the present invention more clearly, the drawings required to be used in description of the embodiments will be simply introduced below, obviously, the drawings described below are only some embodiments of the present invention, and other drawings can further be obtained by those of ordinary skill in the art according to the drawings without creative work.

FIG. 1 is an overall flow chart of a power grid transmission and distribution cooperative dispatching method in a power market environment provided by a first embodiment of the present invention;

FIG. 2 is a water-electricity conversion relationship diagram of piecewise linearization of a power grid transmission and distribution cooperative dispatching method in a power market environment provided by a first embodiment of the present invention;

FIG. 3 is a flow chart of power grid dispatching realizing solving by adopting Benders decomposition of a power grid transmission and distribution cooperative dispatching method in a power market environment provided by a first embodiment of the present invention;

FIG. 4 is an output diagram of a 118-node unit of a power grid transmission and distribution cooperative dispatching method in a power market environment provided by a second embodiment of the present invention; and

FIG. 5 is an overall flow chart of a power grid transmission and distribution cooperative dispatching system in a power market environment provided by a third embodiment of the present invention.

### DETAILED DESCRIPTION OF THE EMBODIMENTS

In order to make the aforementioned purposes, features and advantages of the present invention more apparent and comprehensible, detailed descriptions of specific implementation modes of the present invention are provided below in conjunction with the appended drawings. It is apparent that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

Embodiment 1

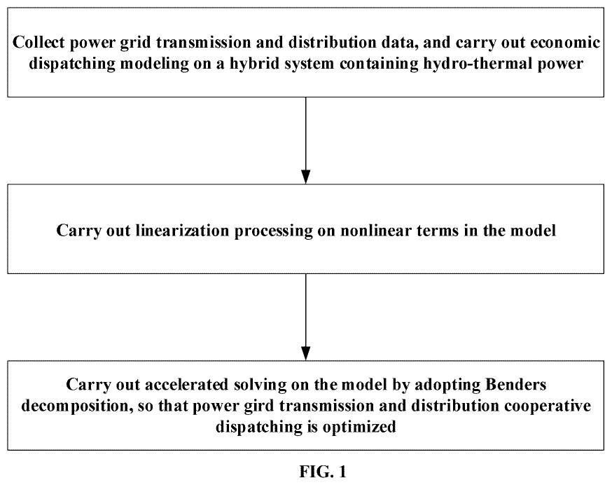

Referring to FIGS. 1-3, an embodiment of the present invention provides a power grid transmission and distribution cooperative dispatching method in a power market environment, which includes the following operations.

S1: power grid transmission and distribution data is collected, and economic dispatching modeling is carried out on a hybrid system containing hydro-thermal power.

Furthermore, the power grid transmission and distribution data includes power generation data, power grid data, market data and environment data; the power generation data includes reservoir level, fuel consumption rate, generator set efficiency and emission efficiency; the power grid data includes real-time load data, line loss and line impedance; the market data includes real-time electricity price; and the environment data includes temperature, humidity and precipitation.

It should be noted that the economic dispatching modeling includes: an optimization objective is that the total operation cost of the system is the minimum, and the total operation cost of the system includes coal consumption cost of operation cost of a thermal power station, startup and shutdown cost of operation cost of the thermal power station and spilled water cost of a hydropower station, expressed as:

$$min F = {\sum }_{i = 1}^{N} {\sum }_{t = 1}^{T} \{ {u}_{i , t} {f}_{i} ( {P}_{i , t} ) + {u}_{i , t} ( 1 - {u}_{i , t - 1} ) {C}_{i , t} \} + {\sum }_{j = 1}^{M} {\sum }_{t = 1}^{T} {λ}_{j} {S}_{j , t}$$

where F is a target function when the total operation cost of the system is the minimum, i and N are respectively the serial number and total number of thermal power generating units, j and M are respectively the serial number and total number of cascade hydropower stations, t and T are respectively time-period serial number and total number, P_{i,t} is output of the ith thermal power generating unit in time period t, u_{i,t} fare state variables of the unit, 0 indicates shutdown state of the unit, 1 indicates startup state, C_{i,t} represents startup cost of the unit i in time period t, S_{j,t} represents spilled water volume of the hydropower station j in time period t, λⱼ is a penalty factor of spilled water of the hydropower station, converting the spilled water volume to spilled water cost, and computing operation time of the unit i in time period t, expressed as:

$${f}_{i} ( {P}_{i , t} ) = {aP}_{i , t}^{2} + {bP}_{i , t} + c$$

where a,b,c is consumption characteristic parameter of operation of the unit.

It is to be noted that the economic dispatching modeling further includes: aiming at a hybrid system containing hydro-thermal power, constraining is carried out on the system, including computing power constraint and rotating reserve constraint of the system, power balance of a power system is balance of power supply and demand, the total power generation of the power system is balanced with total load of a power distribution network connected to an active network, and modeling is carried out on power balance constraint, expressed as:

$${\sum }_{i = 1}^{N} {P}_{i , t} + {\sum }_{j = 1}^{M} {P}_{j , t} = {D}_{t}$$

P_{i,t} [symbol] P_{j,t} respectively represent output of a thermal power generating unit i and a hydropower station j in time period t, Dₜ represents algebraic sum of equivalent load of different power distribution networks in time period t, distributed power resources are connected to the power distribution network, the power distribution network changes from passive to active network, and during calculation and analysis of the active network, if there are excessive distributed power resources in the power distribution network, the equivalent load is negative; and calculating rotating reserve constraint, expressed as:

$${\sum }_{i = 1}^{N} {u}_{i , t} ( {P}_{i , max} - {P}_{i , t} ) + {\sum }_{j = 1}^{M} {u}_{j , t} ( {P}_{j , max} - {P}_{j , t} ) = {η}_{t} {D}_{t}$$

P_{i,max} [symbol] P_{j,max} respectively represent upper limits of output of the thermal power generating unit i and the hydropower station j, and ηₜrepresents a coefficient of reserve capacity of the system in time period t; establishing operation constraint of the unit, including output constraint, climbing constraint and minimum startup-shutdown time constraint of the unit; and calculating output constraint of the unit, expressed as:

$$\{ \begin{matrix}{P}_{i , min} \leq {P}_{i , t} \leq {P}_{i , max} \\ {P}_{j , min} \leq {P}_{j , t} \leq {P}_{i , max}\end{matrix}$$

P_{i,min} [symbol] P_{j,min} respectively represent lower limits of output of the thermal power generating unit i and the hydropower station j; and calculating climbing constraint, expressed as:

$$\{ \begin{matrix}\vert {P}_{i , t} - {P}_{i , t - 1} \vert \leq {R}_{i , max} \\ \vert {P}_{j , t} - {P}_{j , t - 1} \vert \leq {R}_{j , max}\end{matrix}$$

R_{i,max} is upper limit of climbing constraint of the thermal power generating unit i, and R_{j,max} represents upper limit of climbing constraint of the hydropower station j; and calculating the minimum startup-shutdown time constraint, expressed as:

$$\{ \begin{matrix}( {u}_{i , t - 1} - {u}_{i , t} ) ( {T}_{i , t - 1} - {\underline{T}}_{i , on} ) \geq 0 \\ ( {u}_{i , t} - {u}_{i , t - 1} ) ( - {T}_{i , t - 1} - {\underline{T}}_{i , off} ) \geq 0\end{matrix}$$

Tₒₙ [symbol] T_{off} are respectively minimum operation time and minimum startup-shutdown of the unit, and T_{i,t} represents continuous operation time or continuous shutdown time of the unit i in time period t; establishing hydropower station constraint, including water volume balance constraint, water head constraint, power generation flow constraint, reservoir outflow constraint, water level constraint, and water level-reservoir capacity and unit output relationship constraint; and calculating the water volume balance constraint, expressed as:

$$\{ \begin{matrix}{V}_{j , t + 1} = {V}_{j , t} + 3600 \times ( {I}_{j , t} - {Q}_{j , t} + {\sum }_{k ∈ {K}_{j}} {Q}_{j , t - {τ}_{j , k}}^{k} ) Δ t \\ {Q}_{j , t} = {q}_{j , t} + {s}_{j , t}\end{matrix}$$

V_{j,t} is reservoir capacity of the station j in time period t, I_{j,t} is reservoir inflow of the station j in time period t, Q_{j,t} is reservoir outflow of the station j in time period t, Q_{j,t-τ}_{_{j,k}}^{k} is reservoir outflow of the station j in the kth direct upstream station in time period t-τ_{j,k}, Kⱼ is a set of direct upstream stations of the station j, τ_{j,k} is flow time-lag of the station j to the upstream station k, q_{i,t}is power generation flow of the station j in time period t, and s_{j,t} is spilled water flow of the station j in time period t; and calculating the water head constraint, expressed as:

$$\{ \begin{matrix}{h}_{j , t} = \frac{{Z}_{j , t} + {Z}_{j , t - 1}}{2} - {h}_{t}^{loss} \\ {h}_{t}^{loss} = {f}_{loss} ( {q}_{j , t} )\end{matrix}$$

h_{j,t} [symbol] Z_{j,t} [symbol] hₜ^{loss} are respectively power generation water head, water level and water head loss of the station j in time period t, and the water head loss and the power generation flow are in a nonlinear relationship; and calculating the power generation flow constraint, the reservoir outflow constraint and the water level constraint, expressed as:

$$\{ \begin{matrix}{\underline{q}}_{j , t} \leq {q}_{j , t} \leq {\overline{q}}_{j , t} \\ {\underline{Q}}_{j , t} \leq {Q}_{j , t} \leq {\overline{Q}}_{j , t} \\ {\underline{Z}}_{j , t} \leq {Z}_{j , t} \leq {\overline{Z}}_{j , t}\end{matrix}$$

q_{j,t} is lower limit of power generation flow of the station j in time period t, q̅_{j,t} is upper limit of power generation flow of the j in time period t, Q_{j,t} is lower limit of reservoir outflow of the station j in time period t, Q̅_{j,t} is upper limit of reservoir outflow of the station j in time period t, Z_{j,t} is lower limit of water level of the station j in time period t, and Z̅_{j,t} is upper limit of water level of the station j in time period t; and calculating the water level-reservoir capacity and unit output relationship constraint, expressed as:

$$\{ \begin{matrix}{Z}_{j , t} = {f}_{j , v} ( {V}_{j , t} ) \\ {P}_{j , t} = {f}_{j , q , h} ( {q}_{j , t} , {h}_{j , t} )\end{matrix}$$

where f_{j,v}(V_{j,t}) represents nonlinear relationship of the water level and reservoir capacity of each hydropower station, and f_{j,q,h}(q_{j,t}, j_{j,t}) represents a two-dimensional relation of output, power generation flow and water head of the station j.

It is also to be noted that the economic dispatching modeling integrates operation characteristics of the thermal power and hydropower stations, so that the operation cost of the power system is minimized, which is beneficial for optimizing resource allocation, and improving economy and efficiency of the power system. By adjusting output of the thermal power generating unit, the operation cost of the thermal power station is effectively managed, especially in the aspects of consumption characteristic parameter and startup and shutdown cost, and the reasonable control and cost evaluation of spilled water volume are beneficial for optimizing operation of the hydropower station, and reducing resource waste.

S2: linearization processing is carried out on nonlinear terms in the model.

Furthermore, the linearization processing includes carrying out target function linearization on the model, a target function includes operation cost of thermal power and spilled water penalty cost of hydropower, coal consumption cost in the operation cost of thermal power is a quadratic function of unit output, the coal consumption cost is a nonlinear function of unit output, and linearization output is carried out, expressed as:

$$\{ \begin{matrix}{f}_{i} ( {P}_{i , t} ) = {\sum }_{m = 1}^{{M}_{max}} {k}_{i , m} {P}_{i , t , m} + {u}_{i , t} ( {aP}_{i , min}^{2} + {bP}_{i , min} + c ) \\ {P}_{i , t} = {\sum }_{m = 1}^{{M}_{max}} {P}_{i , t , m} + {u}_{i , t} {P}_{i , min} \\ 0 \leq {P}_{i , t , m} \leq Δ {P}_{i , m}\end{matrix}$$

where m [symbol] Mₘₐₓ are serial number and total segment number of linearization segments, k_{i,m}is the slope of the mth segment after an operation cost curve of the thermal power generating unit is linearized, P_{i,t,m}is output of the unit i in the mth segment in time period t, and ΔP_{i,t} is a power difference of the average segment.

It is to be noted that the linearization processing further includes carrying out linearization on a nonlinear relationship constraint existing; and the water level-reservoir capacity and water head loss-power generation flow are respectively in one-dimensional nonlinear relationship, linear interpolation is carried out on the nonlinear function by introducing 0-1 variable in the water level-reservoir capacity function, and the linearized model is expressed as:

$$\{ \begin{matrix}{\underline{V}}_{j} = {V}_{j}^{0} < {V}_{j}^{1} < … < {V}_{j}^{k} < … {V}_{j}^{K} = {\overline{V}}_{j} \\ {r}_{j , t}^{k} {V}_{j}^{k - 1} \leq {V}_{j , t}^{k} \leq {r}_{j , t}^{k} {V}_{j}^{k} \\ {Z}_{j , t} = {\sum }_{k = 1}^{K} \{ {r}_{j , t}^{k} {Z}_{j}^{k - 1} + \frac{{Z}_{j}^{k} - {Z}_{j}^{k - 1}}{{V}_{j}^{k} - {V}_{j}^{k - 1}} \times ( {V}_{j , t}^{k} - {r}_{j , t}^{k} {V}_{j}^{k - 1} ) \}\end{matrix}$$

Zⱼ^{k} [symbol] Vⱼ^{k} respectively represent water level and reservoir capacity segmentation points of a water level-reservoir capacity curve of the station j, the numerical correspondence of the segmentation points is based on historical data, Vⱼ represents lower limit of reservoir capacity of the station j, V̅ⱼ represents upper limit of reservoir capacity of the station j, V_{j,t}^{k} represents the value of reservoir capacity of the station j in the kth interval during time period t, and r_{j,t}^{k} are indicator variables 0-1, which represent whether the reservoir capacity of the station j is in the kth discrete interval or not during time period t, where 1 means it is in the interval, and 0 means that it is not in the interval. Output constraint of the hydropower unit is two-dimensional nonlinear constraint, by discretizing the reservoir capacity and power generation flow into n and m segments respectively, the average value of the upper and lower limits of each segment of reservoir capacity is taken as the interval reservoir capacity of the segment, for a specific reservoir capacity interval, unit output is simplified into a unary function of power generation flow, and the linearization relationship is calculated by piecewise interpolation.

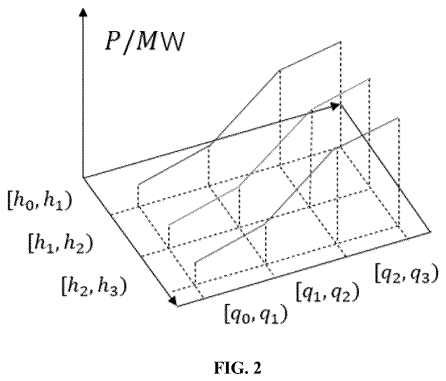

It is also to be noted that referring to a water-electricity conversion relationship diagram of piecewise linearization of FIG. 2, in one-dimensional nonlinear relationship of the water level-reservoir capacity and water head loss-power generation flow, 0-1 variables are introduced for carrying out linear interpolation, then a complex operation model of a hydropower station may be converted to a linear model easy to process, which makes operation optimization of the hydropower station possible, the flexibility and accuracy of management of the hydropower station are improved, for the two-dimensional nonlinear constraint of output of the hydropower unit, linearization is realized by means of discretization and piecewise interpolation, so that the calculation process of output dispatching is greatly simplified, and the accuracy and operation of dispatching are improved.

S3: accelerated solving is carried out on the model by adopting Benders decomposition, so that power gird transmission and distribution cooperative dispatching is optimized.

Furthermore, accelerated solving on the model by adopting Benders decomposition includes: an original problem is decomposed into main and sub problems based on model linearization by adopting the Benders decomposition method, main and sub problems are alternately solved, the optimal solution is calculated, the main problem is a unit combination problem without safety constraint, and the sub problem is power flow verification of the system.

When the value of a target function of the sub problem in the time period is smaller than a threshold, the solution of the main problem meets a power flow equation and operation constraint in the time period t, and the sub problem is a feasible sub problem.

when the value of the target function of the sub problem in time period is greater than or equal to a threshold, the solution of the main problem cannot meet a power flow equation and operation constraint in the time period t, the sub problem is an infeasible sub problem, for the infeasible sub problem, feeding out-of-limit information back to the main problem, correcting the solution of the main problem in the corresponding time period, and performing Benders decomposition in the correction process, expressed as:

$${\sum }_{l ∈ L} ( {ε}_{l}^{+} + {ε}_{l}^{-} ) + {\sum }_{i ∈ N} {λ}_{p , i} ( {P}_{i} - {P}_{i}^{0} ) + {\sum }_{i ∈ N} {λ}_{u , i} ( {U}_{i} - {U}_{i}^{0} ) \leq 0$$

where εₗ⁺ [symbol] εₗ⁻ are forward power flow slack and reverse power flow slack of a line l respectively, λ_{p,i} [symbol] λ_{u,i} are Lagrangian multipliers of unit output constraint and startup-shutdown state constraint respectively, Pᵢ⁰ [symbol] Uᵢ⁰ are respectively values of upper iteration, and carrying out power grid transmission and distribution cooperative dispatching optimization based on a decomposed model.

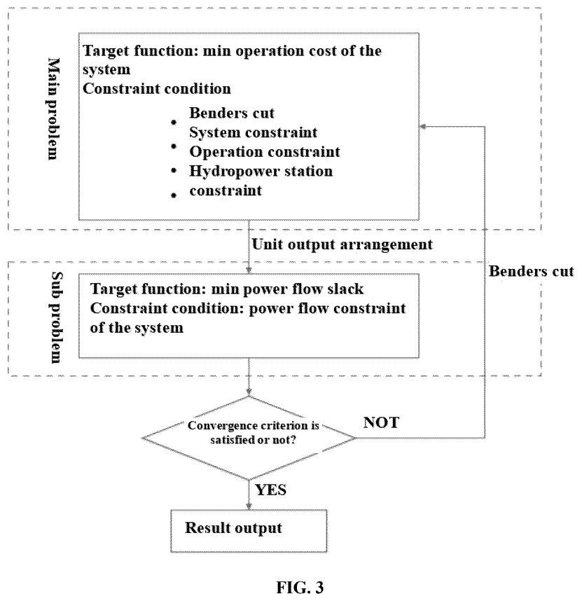

It is to be noted that, by referring to a flow chart of power grid dispatching realizing solving by adopting Benders decomposition of FIG. 3, accelerated solving is carried out on the model by adopting the Benders decomposition method, through model conversion, the established model may be solved by an existing solver, however, as the scale of the system increases, the required time index increases, and in order to accelerate the solving speed, accelerated processing is carried out by adopting Benders solving.

It is also to be noted that the alternating solving method of the main and sub problems not only simplifies the calculation process, but also gradually approximates the optimal solution through continuous iterative optimization, so that the accuracy and reliability of the solved result are ensured, when the value of a target function of the sub problem is lower than a preset threshold, it indicates that the current solution satisfies the power flow equation and operation constraint of the power system, and it is feasible, when the value of the target function is higher than the threshold, the solution of the main problem needs to be corrected, Benders cut adopted in the correction process provides an effective feedback mechanism to ensure the safety and stability of operation of the power system, the optimization of the whole process improves adaption and flexibility of the power system in the complex operation environment, which has important practical significance for power market and power system operation, and the economy of resource allocation and the reliability of system operation are improved.

Embodiment 2

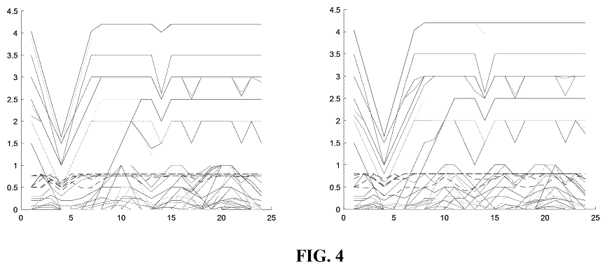

Referring to FIGS. 4, an embodiment of the present invention provides a power grid transmission and distribution cooperative dispatching method in a power market environment, in order to verify the beneficial effects of the present invention, scientific demonstration is performed through economic benefit calculation and a simulation experiment.

First, an IEEE118 node system includes 48 thermal power generating units and 6 hydropower units, the power transmission network is responsible for power supply of 91 power distribution systems, besides accelerated solving of Benders solving, solving without acceleration is also carried out, namely, power grid transmission and distribution data is only collected, and economic dispatching modeling is carried out on a hybrid system containing hydro-thermal power; and linearization processing is carried out on nonlinear terms in the model.

Table 1 lists the comparison in solving speed and accuracy of the two solving methods.

TABLE 1
Comparison analysis table of two methods

| | Not adopting Benders | Adopting Benders |
|---|---|---|
| Item | decomposition | decomposition |
| Calculating speed (s) | 137 | 128 |
| Operation cost (p.u.) | 1 | 1.19 |

FIG. 4 is an output diagram of a 118-node unit, Benders decomposition is not adopted (left), Benders decomposition is adopted (right), and the operation cost is based on the result of a traditional method.

The Benders decomposition method decomposes the unit combination problem into two problems: a main problem and a sub problem, the main problem is configured to solve the optimal condition of the unit combination, and in such a case, power flow constraint of the system is not considered; the sub problem is configured to carry out power flow verification of the system, for a solution of an infeasible main problem, a Benders feasible cut containing system slack and Lagrange multiplier is returned to the main problem, the main problem is resolved to obtain a new unit combination condition, then power flow verification of the system is carried out again, and through iteration, when slack of the sub problem is small enough, an optimal unit combination condition is obtained; although the Benders decomposition method needs iteration, the scales of the main problem and sub problem are smaller than that of the original problem, so the solving speed is higher, as the scale of the system increases, the acceleration effect becomes more obvious, from the perspective of operation cost, compared with direct solving, the operation cost of the Benders decomposition method is partly improved, that is, the improvement of calculation speed of the Benders decomposition method is based on the condition that calculation accuracy is sacrificed, and due to the creativity and novelty of the present disclosure compared to those of the relevant art, especially in improving the operation efficiency of the power system and reducing cost, the present disclosure are creative.

Embodiment 3

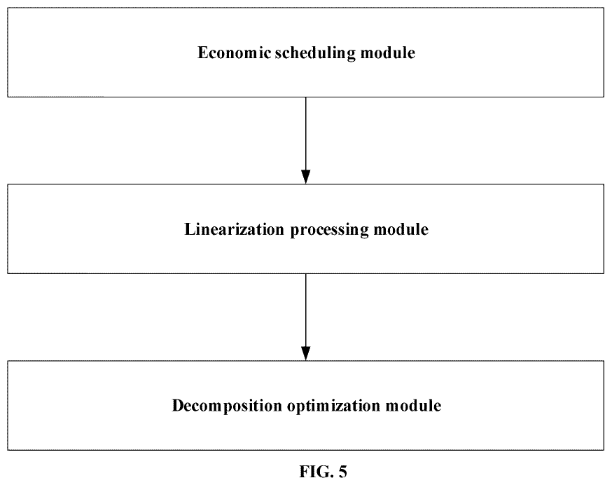

Referring to FIG. 5, an embodiment of the present invention provides a power grid transmission and distribution cooperative dispatching system in a power market environment, which includes an economic dispatching module, a linearization processing module and a decomposition optimization module.

The economic dispatching module is configured to collect power grid transmission and distribution data, and carry out economic dispatching modeling on a hybrid system containing hydro-thermal power; the linearization processing module is configured to carry out linearization processing on nonlinear terms in the model and carry out linearization on a target function of the model and nonlinear relationship constraint; and the decomposition optimization module is configured to carry out accelerated solving on the model by adopting Benders decomposition, so that power gird transmission and distribution cooperative dispatching is optimized.

If a function is implemented in a form of a software functional unit, and sold or used as an independent product, the function may be stored in a computer-readable storage medium. Based on this understanding, the technical solution of the present invention essentially or a part that contributes to the prior art, or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The foregoing storage medium includes any medium that may store program codes, such as a U disk, a removable hard disk, a Read-Only Memory (ROM), a Random Access Memory (RAM), a magnetic disk, or an optical disc.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of this specification, the “computer-readable medium” may be any apparatus that may contain, store, communicate, propagate or transmit a program for use by the instruction execution systems, the apparatuses, or the devices or in a combination manner.

More specific examples (non-exhaustive list) of the computer-readable medium may include the following: an electrical connection (an electronic apparatus) with one or more wires, a portable computer disk case (a magnetic apparatus), a Random Access Memory (RAM), a Read-Only Memory (ROM), an Erasable Programmable Read-Only Memory (EPROM or flash memory), an optical fiber, and a portable Compact Disk Read-Only Memory (CDROM). In addition, the computer-readable medium may even be paper or other appropriate media on which the program may be printed, it because that the program may be acquired electronically, for example, by optically scanning the paper or other media, followed by editing, interpretation or, if necessary, other appropriate processing ways, and then stored in a computer memory.

It should be understood that each part of the present invention be achieved by hardware, software, firmware or a combination thereof. In the above implementation, multiple steps or methods can be implemented with the software or the firmware stored in the memory and executed by the appropriate instruction execution system. For example, if they are implemented by the hardware, as in another implementation mode, they may be implemented by any one of the following technologies well known in the art or their combination: a discrete logic circuit with a logic gate circuit for implementing a logic function of a data signal, a special integrated circuit with an appropriate combinational logic gate circuit, a Programmable Gate Array (PGA), a Field Programmable Gate Array (FPGA), etc. It should be noted that the above embodiments are only used to illustrate the technical solution of the present invention and are not for limitation. Although the present invention is described in detail with reference to the preferred embodiments, those of ordinary skill in the art should understand that the technical solutions of the present invention may be modified or replaced by equivalents without departing from the spirit and scope of the technical solutions of the present invention, and all those modifications or replacements should be included in the scope of the claims of the present invention.

It should be noted that, the above examples are merely used for illustrating the technical solution of the present invention and are not for limitation, although the present invention is described in detail with reference to the preferred examples, those of ordinary skill in the art should understand that, the technical solutions of the present invention may be modified or equivalently substituted without departing from the spirit and scope of the technical solution of the present invention, and all those modifications or replacements should be included in the scope of the claims of the present invention.

What is claimed is:

1. A power grid transmission and distribution cooperative dispatching method in a power market environment, comprising:
collecting power grid transmission and distribution data, and carrying out economic dispatching modeling on a hybrid system containing hydro-thermal power;
carrying out linearization processing on nonlinear terms in the model; and
carrying out accelerated solving on the model by adopting Benders decomposition, so that power gird transmission and distribution cooperative dispatching is optimized.

2. The power grid transmission and distribution cooperative dispatching method in a power market environment of claim 1, wherein the power grid transmission and distribution data comprises power generation data, power grid data, market data and environment data;
the power generation data comprises reservoir level, fuel consumption rate, generator set efficiency and emission efficiency;
the power grid data comprises real-time load data, line loss and line impedance;
the market data comprises real-time electricity price; and
the environment data comprises temperature, humidity and precipitation.

3. The power grid transmission and distribution cooperative dispatching method in a power market environment of claim 2, wherein the economic dispatching modeling comprises that an optimization objective is that the total operation cost of the system is the minimum, and the total operation cost of the system comprises coal consumption cost of operation cost of a thermal power station, startup and shutdown cost of operation cost of the thermal power station and spilled water cost of a hydropower station, expressed as:
$$min F = {\sum }_{i = 1}^{N} {\sum }_{t = 1}^{T} \{ {u}_{i , t} {f}_{i} ( {P}_{i , t} ) + {u}_{i , t} ( 1 - {u}_{i , t - 1} ) {C}_{i , t} \} + {\sum }_{j = 1}^{M} {\sum }_{t = 1}^{T} {λ}_{j} {S}_{j , t}$$
wherein F is a target function when the total operation cost of the system is the minimum, i and N are respectively the serial number and total number of thermal power generating units, j and M are respectively the serial number and total number of cascade hydropower stations, t and T are respectively time-period serial number and total number, P_{i,t} is output of the ith thermal power generating unit in time period t, u_{i,t} are state variables of the unit, 0 indicates shutdown state of the unit, 1 indicates startup state, C_{i,t} represents startup cost of the unit i in time period t, S_{j,t} represents spilled water volume of the hydropower station j in time period t, λⱼ is a penalty factor of spilled water of the hydropower station, converting the spilled water volume to spilled water cost, and computing operation time of the unit i in time period t, expressed as:
$${f}_{i} ( {P}_{i , t} ) = {aP}_{i , t}^{2} + {bP}_{i , t} + c$$
wherein a,b,c is consumption characteristic parameter of operation of the unit.

4. The power grid transmission and distribution cooperative dispatching method in a power market environment of claim 3, wherein the economic dispatching modeling further comprises: aiming at a hybrid system containing hydro-thermal power, carrying out constraining on the system, comprising calculating system power constraint and rotating reserve constraint, power balance of a power system is balance of power supply and demand, the total power generation of the power system is balanced with total load of a power distribution network connected to an active network, and carrying out modeling on power balance constraining, expressed as:
$${\sum }_{i = 1}^{N} {P}_{i , t} + {\sum }_{j = 1}^{M} {P}_{j , t} = {D}_{t}$$
wherein P_{i,t} [symbol] P_{i,t}respectively represent output of a thermal power generating unit i and a hydropower station j in time period t, Dₜ represents algebraic sum of equivalent load of different power distribution networks in time period t, distributed power resources are connected to the power distribution network, the power distribution network changes from passive to active network, and during calculation and analysis of the active network, if there are excessive distributed power resources in the power distribution network, the equivalent load is negative;
computing rotating reserve constraint, expressed as:
$${\sum }_{i = 1}^{N} {u}_{i , t} ( {P}_{i , max} - {P}_{i , t} ) + {\sum }_{j = 1}^{M} {u}_{j , t} ( {P}_{j , max} - {P}_{j , t} ) = {η}_{t} {D}_{t}$$
wherein P_{i,max} [symbol] P_{j,max} respectively represent upper limits of output of the thermal power generating unit i and the hydropower station j, and ηₜ represents a coefficient of reserve capacity of the system in time period t;
establishing operation constraint of the unit, comprising output constraint, climbing constraint and minimum startup-shutdown time constraint of the unit;
computing output constraint of the unit, expressed as:
$$\{ \begin{matrix}{P}_{i , min} \leq {P}_{i , t} \leq {P}_{i , max} \\ {P}_{j , min} \leq {P}_{j , t} \leq {P}_{i , max}\end{matrix}$$
wherein P_{i,min} [symbol] P_{j,min} respectively represent lower limits of output of the thermal power generating unit i and the hydropower station j;
computing climbing constraint, expressed as:
$$\{ \begin{matrix}\vert {P}_{i , t} - {P}_{i , t - 1} \vert \leq {R}_{i , max} \\ \vert {P}_{j , t} - {P}_{j , t - 1} \vert \leq {R}_{j , max}\end{matrix}$$
wherein R_{i,max} is upper limit of climbing constraint of the thermal power generating uniti, and R_{j,max} represents upper limit of climbing constraint of the hydropower station j;
computing minimum startup-shutdown time constraint, expressed as:
$$\{ \begin{matrix}( {u}_{i , t - 1} - {u}_{i , t} ) ( {T}_{i , t - 1} - {\underline{T}}_{i , on} ) \geq 0 \\ ( {u}_{i , t} - {u}_{i , t - 1} ) ( - {T}_{i , t - 1} - {\underline{T}}_{i , off} ) \geq 0\end{matrix}$$
wherein Tₒₙ [symbol] T_{off}are respectively minimum operation time and minimum stop time of the unit, and T_{i,t} represents continuous operation time or continuous shutdown time of the unit i in time period t;
establishing hydropower station constraint, comprising water volume balance constraint, water head constraint, power generation flow constraint, reservoir outflow constraint, water level constraint, and water level-reservoir capacity and unit output relationship constraint;
computing water volume balance constraint, expressed as:
$$\{ \begin{matrix}{V}_{j , t + 1} = {V}_{j , t} + 3600 \times ( {I}_{j , t} - {Q}_{j , t} + {\sum }_{k ∈ {K}_{j}} {Q}_{j , t - {τ}_{j , k}}^{k} ) Δ t \\ {Q}_{j , t} = {q}_{j , t} + {s}_{j , t}\end{matrix}$$
wherein V_{j,t} is reservoir capacity of the station j in time period t, I_{j,t} is reservoir inflow of the station j in time period t, Q_{j,t}is reservoir outflow of the station j in time period t, Q_{j,t-τ}_{_{j,k}}^{k} is reservoir outflow of the station j in the kth direct upstream station in time period t-τ_{j,k}, Kⱼ is a set of direct upstream stations of the station j, τ_{j,k} is flow time-lag of the station j to the upstream station k, q_{j,t} is power generation flow of the station j in time period t, and s_{j,t} is spilled water flow of the station j in time period t;
computing water head constraint, expressed as:
$$\{ \begin{matrix}{h}_{j , t} = \frac{{Z}_{j , t} + {Z}_{j , t - 1}}{2} - {h}_{t}^{loss} \\ {h}_{t}^{loss} = {f}_{l o s s} ( {q}_{j , t} )\end{matrix}$$
wherein h_{j,t} [symbol] Z_{j,t} [symbol] hₜ^{loss} are respectively power generation water head, water level and water head loss of the station j in time period t, and the water head loss and the power generation flow are in a nonlinear relationship;
computing the power generation flow constraint, the reservoir outflow constraint and the water level constraint, expressed as:
$$\{ \begin{matrix}{\underline{q}}_{j , t} \leq {q}_{j , t} \leq {\overline{q}}_{j , t} \\ {\underline{Q}}_{j , t} \leq {Q}_{j , t} \leq {\overline{Q}}_{j , t} \\ {\underline{Z}}_{j , t} \leq {Z}_{j , t} \leq {\overline{Z}}_{j , t}\end{matrix}$$
wherein q_{i,t} is lower limit of power generation flow of the station j in time period t, q_{j,t} is upper limit of power generation flow of the j in time period t, Q_{j,t} is lower limit of reservoir outflow of the station j in time period t, Q̅_{j,t} is upper limit of reservoir outflow of the station j in time period t, Z_{j,t} is lower limit of water level of the station j in time period t, and Z̅_{j,t} is upper limit of water level of the station j in time period t; and
computing water level-reservoir capacity and unit output relationship constraint, expressed as:
$$\{ \begin{matrix}{Z}_{j , t} = {f}_{j , v} ( {V}_{j , t} ) \\ {P}_{j , t} = {f}_{j , q , h} ( {q}_{j , t} , {h}_{j , t} )\end{matrix}$$
wherein f_{j,v}(V_{j,t}) represents nonlinear relationship of the water level and reservoir capacity of each hydropower station, and f_{j,q,h}(q_{j,t}, h_{j,t}) represents a two-dimensional relation of output, power generation flow and water head of the station j.

5. The power grid transmission and distribution cooperative dispatching method in a power market environment of claim 4, wherein the linearization processing comprises carrying out target function linearization on the model, a target function comprises operation cost of thermal power and spilled water penalty cost of hydro-power, coal consumption cost in the operation cost of thermal power is a quadratic function of unit output, the coal consumption cost is a nonlinear function of unit output, and carrying out linearization output, expressed as:
$$\{ \begin{matrix}{f}_{i} ( {P}_{i , t} ) = {\sum }_{m = 1}^{{M}_{max}} {k}_{i , m} {P}_{i , t , m} + {u}_{i , t} ( a {P}_{i , min}^{2} + b {P}_{i , min} + c ) \\ {P}_{i , t} = {\sum }_{m = 1}^{{M}_{max}} {P}_{i , t , m} + {u}_{i , t} {P}_{i , min} \\ 0 \leq {P}_{i , t , m} \leq Δ {P}_{i , m}\end{matrix}$$
wherein m [symbol] Mₘₐₓ are serial number and total segment number of linearization segments, k_{i,m} is the slope of the mth segment after an operation cost curve of the thermal power generating unit is linearized, P_{i,t,m} is output of the unit i in the mth segment in time period t, and ΔP_{i,t} is a power difference of the average segment.

6. The power grid transmission and distribution cooperative dispatching method in a power market environment of claim 5, wherein the linearization processing further comprises carrying out linearization on a nonlinear relationship constraint existing;
the water level-reservoir capacity and the water head loss-power generation flow are respectively in one-dimensional nonlinear relationship, carrying out linear interpolation on the nonlinear function by introducing 0-1 variables in the water level-reservoir capacity function, and the linearized model is expressed as:
$$\{ \begin{matrix}{\underline{V}}_{j} = {V}_{j}^{0} < {V}_{j}^{1} < … < {V}_{j}^{k} < … {V}_{j}^{K} = {\overline{V}}_{j} \\ {r}_{j , t}^{k} {V}_{j}^{k - 1} \leq {V}_{j , t}^{k} \leq {r}_{j , t}^{k} {V}_{j}^{k} \\ {Z}_{j , t} = {\sum }_{k = 1}^{K} \{ {r}_{j , t}^{k} {Z}_{j}^{k - 1} + \frac{{Z}_{j}^{k} - {Z}_{j}^{k - 1}}{{V}_{j}^{k} - {V}_{j}^{k - 1}} \times ( {V}_{j , t}^{k} - {r}_{j , t}^{k} {V}_{j}^{k - 1} ) \}\end{matrix}$$
wherein Zⱼ^{k} [symbol] Vⱼ^{k}respectively represent water level and reservoir capacity segmentation points of a water level-reservoir capacity curve of the station j, the numerical correspondence of the segmentation points is based on historical data, Vⱼ represents lower limit of reservoir capacity of the station j, V̅ⱼ represents upper limit of the reservoir capacity of the station j, V_{j,t}^{k} represents the value of reservoir capacity of the station j in the kth interval during time period t, r_{j,t}^{k} are indicator variables 0-1, which represent whether the reservoir capacity of the station j is in the kth discrete interval or not during time period t, wherein 1 indicates that it is in the interval, and 0 indicates that it is not in the interval;
output constraint of the hydropower unit is two-dimensional nonlinear constraint, by discretizing the reservoir capacity and power generation flow into n and m segments respectively, the average value of the upper and lower limits of each segment of the reservoir capacity is taken as the interval reservoir capacity of the segment, for a specific reservoir capacity interval, the output of the unit is simplified into a unary function of power generation flow, and the linearization relationship is calculated by piecewise interpolation.

7. The power grid transmission and distribution cooperative dispatching method in a power market environment of claim 6, wherein carrying out accelerated solving on the model by adopting Benders decomposition comprises: decomposing an original problem into main and sub problems based on model linearization by adopting a Benders decomposition method, alternately solving main and sub problems, calculating an optimal solution, the main problem is a unit combination problem without safety constraint, and the sub problem is power flow verification of the system;
when the value of a target function of the sub problem in time period is smaller than a threshold, the solution of the main problem meets a power flow equation and operation constraint in the time period t, and the sub problem is a feasible sub problem;
when the value of the target function of the sub problem in time period is greater than or equal to a threshold, the solution of the main problem cannot meet a power flow equation and operation constraint in the time period t, the sub problem is an infeasible sub problem, for the infeasible sub problem, feeding out-of-limit information back to the main problem, correcting the solution of the main problem in the corresponding time period, and performing Benders decomposition in the correction process, expressed as:
$${\sum }_{l ∈ L} ( {ε}_{l}^{+} + {ε}_{l}^{-} ) + {\sum }_{i ∈ N} {λ}_{p , i} ( {P}_{i} - {P}_{i}^{0} ) + {\sum }_{i ∈ N} {λ}_{u , i} ( {U}_{i} - {U}_{i}^{0} ) \leq 0$$
wherein εₗ⁺ [symbol] εₗ⁻ are forward power flow slack and reverse power flow slack of a line l respectively, λ_{p,i} [symbol] λ_{u,i} are Lagrangian multipliers of unit output constraint and startup-shutdown state constraint respectively, Pᵢ⁰ [symbol] Uᵢ⁰ are respectively values of upper iteration, and carrying out power grid transmission and distribution cooperative dispatching optimization based on a decomposed model.

8. A system adopting the power grid transmission and distribution cooperative dispatching method in a power market environment of claim 1, comprising an economic dispatching module, a linearization processing module and a decomposition optimization module;
the economic dispatching module is configured to collect power grid transmission and distribution data, and carry out economic dispatching modeling on a hybrid system containing hydro-thermal power;
the linearization processing module is configured to carry out linearization processing on nonlinear terms in the model, and carry out linearization on the target function of the module and the non-linear relationship constraint; and
the decomposition optimization module is configured to carry out accelerated solving on the model by adopting Benders decomposition, so that power gird transmission and distribution cooperative dispatching is optimized.

9. A computer device, comprising a memory and a processor, a computer program is stored on the memory, wherein when the computer program is executed by the processor, the steps of the power grid transmission and distribution cooperative dispatching method in a power market environment of claim 1 are implemented.

10. A computer-readable storage medium in which a computer program is stored, wherein when the computer program is executed by a processor, the steps of the power grid transmission and distribution cooperative dispatching method in a power market environment of claim 1 are implemented.
